(19) United States
(12) Patent Application Publication
(10) Pub. No.: US 2026/0189313 A1
(43) Pub. Date: Jul. 2, 2026

(54) Improving Holdover of a PTP Network in BTCA using Frequency Support

(71) Applicant: Ciena Corporation, Hanover, MD (US)

(72) Inventors: Arshad Saleem A, Bangalore (IN); Ankur Saxena, Bangalore (IN); Sharad Srivastava, Varanasi (IN)

(73) Assignee: Ciena Corporation, Hanover, MD (US)

(21) Appl. No.: 19/048,078

(22) Filed: Feb. 7, 2025

(30) Foreign Application Priority Data
Dec. 26, 2024 (IN) 202411103327

(51) Int. Cl. H04J 3/06

(52) U.S. Cl. CPC H04J 3/0667; H04J 3/0641

(57) ABSTRACT

Systems and methods for enhancing time holdover in a Precision Time Protocol (PTP) network involve leveraging the best available frequency support while disqualifying time input from a degraded PTP clock. A method includes steps of entering holdover in Precision Time Protocol (PTP) indicating a degraded time synchronization state; determining parameters for a Best Time Clock Algorithm (BTCA), the parameters including a Frequency Traceable flag; providing the parameters to other nodes in the network; and implementing the BTCA including consideration of the Frequency Traceable flag, to select a Best Time Transmitter (BTT) while in the holdover.

### FIELD OF THE DISCLOSURE

The present disclosure relates generally to networking. More particularly, the present disclosure relates to systems and methods for enhancing time holdover in a Precision Time Protocol (PTP) network.

### BACKGROUND OF THE DISCLOSURE

ITU-T G.8275.1, Precision time protocol telecom profile for phase/time synchronization with full timing support from the network. (11/2022), provides detailed recommendations for Precision Time Protocol (PTP) networks with Full Timing Support (FTS). This standard is based on IEEE 1588: IEEE Standard for a Precision Clock Synchronization Protocol for Networked Measurement and Control Systems (2019), commonly known as PTP, and G. 8275.1 extends IEEE 1588 specifically for telecommunications applications. It defines precise requirements for timing distribution in packet-based networks, including clock distribution architectures, protocol scenarios, and network behaviors. The protocol is designed to ensure high-accuracy time and phase synchronization in telecom environments. ITU-T G.8273.2, Timing characteristics of telecom boundary clocks and telecom time slave clocks (06/2023), complements G.8275.1 by specifying performance requirements for PTP equipment and clocks, such as time error tolerance and wander performance. These specifications help maintain consistent and accurate timing distribution across fully supported networks. Similarly, ITU-T G.8275.2, Precision time protocol telecom profile for phase/time synchronization with partial timing support from the network (11/2022), provides recommendations for PTP networks with Partial Timing Support (PTS). Unlike FTS networks, PTS networks operate where not all network elements provide timing support. This standard enables deployment in more flexible and less tightly controlled network environments. The performance criteria for PTS networks are defined in ITU-T G.8273.4, Timing characteristics of telecom time slave clocks with partial timing support (08/2024). This standard includes specifications for equipment and network performance in partial timing support scenarios, ensuring operational accuracy even when timing gaps exist. The contents of ITU-T G.8275.1 (11/2022), ITU-T G.8273.2 (06/2023), ITU-T G.8275.2 (11/2022) and G.8275.2 Amd. 1 (01/2024), and ITU-T G.8273.4 (08/2024) are incorporated by reference in their entirety.

### BRIEF SUMMARY OF THE DISCLOSURE

The present disclosure relates to systems and methods for enhancing time holdover in a Precision Time Protocol (PTP) network involve leveraging the best available frequency support while disqualifying time input from a degraded PTP clock. The ITU-T standards described herein include Best Time Transmitter Selection Algorithm (BTCA) based on IEEE 1588, with an alternate variant known as A-BTCA. The primary goal of BTCA is to select the Best Time Transmitter (BTT) among available PTP Time Transmitters in a network. The selection process relies on the evaluation of PTP Announce message parameters, such as priority values, clock quality, and Grandmaster Clock (GMC) attributes. These parameters are compared in a predefined sequence to identify the most suitable Time Transmitter. Despite its robustness, the BTCA algorithm may not always yield an optimal selection from a topological perspective, especially in complex network configurations. For instance, the best PTP Time Transmitter chosen by BTCA might be located in a less favorable part of the network, potentially introducing higher delays or synchronization inaccuracies. This limitation highlights the need for complementary strategies or additional optimization mechanisms in certain scenarios.

Currently, Precision Time Protocol (PTP) lacks a mechanism to differentiate between two nodes in holdover mode to select the better option. Ideally, the optimal choice between two nodes in holdover is the one with superior frequency backup, as this contributes to more stable and accurate timing. Extended holdover durations, often spanning several hours, are critical for maintaining synchronization in the absence of an active timing source. The proposed solution enables a node to evaluate and select the better option between two nodes entering holdover. These nodes could either be “self and a foreign time transmitter” or “two foreign time transmitters.” By selecting the node with superior frequency backup, the system improves network timing resilience during holdover periods. This disclosure focuses on maintaining accurate time synchronization during degraded network conditions or clock failures. By prioritizing stable and reliable frequency sources, the system ensures continuous synchronization performance. Simultaneously, it actively detects and excludes PTP clocks exhibiting degraded or unreliable time input, preventing the propagation of erroneous timing information across the network. This method significantly enhances the robustness and reliability of time holdover, particularly in scenarios where network stability is compromised.

In various embodiments, the present disclosure contemplates implementation as a method having steps, via a network element with circuitry configured to implement the steps, and as a non-transitory computer-readable medium storing instructions that, when executed, cause one or more processors to implement the steps. The steps include entering holdover in Precision Time Protocol (PTP) indicating a degraded time synchronization state; determining parameters for a Best Time Clock Algorithm (BTCA), the parameters including a Frequency Traceable flag; providing the parameters to other nodes in the network; and implementing the BTCA including consideration of the Frequency Traceable flag, to select a Best Time Transmitter (BTT) while in the holdover.

The BTT is a local Primary Reference Clock (PRC) having frequency traceability. The frequency traceability is to a Synchronous Ethernet (SyncE) source. The Frequency Traceable flag can be set to TRUE, and the consideration of the Frequency Traceable flag in the BTCA includes selecting a clock where the Frequency Traceable flag is TRUE over another clock where it is FALSE. The consideration of the Frequency Traceable flag in the BTCA includes selecting a clock where the Frequency Traceable flag is TRUE over another clock where it is FALSE. The various parameters include one or more of clockClass, clockAccuracy, OffsetScaledLogVariance, priority2, localPriority, and clockIdentity. The BTCA selects a clock having a lower value of the various parameters or the Frequency Traceable flag as TRUE.

The BCTA can select a clock having values of the parameters which are preferred, according to a predetermined selection scheme, the selection scheme including that the Frequency Traceable flag being TRUE is preferred over the Frequency Traceable flag being FALSE. The Frequency Traceable flag is set based on whether a clock's frequency is traceable to a primary reference. The Frequency Traceable flag can be set to FALSE, and wherein the implementing the BTCA including consideration of the Frequency Traceable flag includes selecting another clock for the BTT with the another clock having its Frequency Traceable flag set to TRUE.

### BRIEF DESCRIPTION OF THE DRAWINGS

The present disclosure is detailed through various drawings, where like components or steps are indicated by identical reference numbers for clarity and consistency.

FIG. 1 illustrates a network diagram of a network for illustration of the problems with the current Best Time Transmitter Clock Algorithm (BTCA) approach.

FIG. 2 illustrates a flowchart of a BTCA process that includes consideration of frequency to overcome the deficiencies described with reference to FIG. 1.

FIG. 3 illustrates a network diagram of the network in FIG. 1 for illustration of the BTCA process of FIG. 2.

FIG. 4 illustrates a network diagram of a network for illustrating another scenario where the BTCA decision may not be optimal based on the conventional approach.

FIG. 5 illustrates a network diagram of the network in FIG. 4 for illustration of the BTCA process of FIG. 2.

FIG. 6 illustrates a block diagram of a network element, depicted in a simplified functional format.

FIG. 7 illustrates a block diagram of an example processing device.

FIG. 8 illustrates a flowchart of a process for an enhanced BTCA process that enhances time holdover in a PTP network involve leveraging the best available frequency support while disqualifying time input from a degraded PTP clock.

### DETAILED DESCRIPTION OF THE DISCLOSURE

In a packet network, a switch, router, or any network device such as an evolved node B (eNodeB) (also referred to herein as a node) use the PTP to achieve time synchronization by exchanging timestamped packets with PTP masters and slaves in the network. The protocol ensures accurate synchronization of clocks across network elements by compensating for delays introduced by packet transmission. The switch acts as either a PTP boundary clock or a PTP transparent clock, where boundary clocks synchronize with an upstream source and distribute timing downstream, while transparent clocks measure and correct for delay variations within the network. This precise timing is critical in 5G applications, where ultra-reliable low-latency communication (URLLC), time-sensitive networking (TSN), and massive machine-type communications (mMTC) demand highly accurate synchronization to meet stringent latency and jitter requirements. The clocks may be synchronized both with respect to the time at which they update to the next state, as well as an indication of the current clock state for example representing a cumulative count of past state changes.

Timing in these networks originates from Primary Reference Clocks (PRCs), which are highly stable and accurate clock sources compliant with ITU-T standards, such as those described herein. PRCs typically derive their timing from atomic clocks or Global Positioning Satellite (GPS) systems, providing the foundation for network-wide synchronization. Secondary Synchronization Units (SSU-A clocks) act as intermediate timing sources that maintain synchronization during short interruptions in PRC availability. These clocks, designed with holdover capabilities, ensure continuity and accuracy of timing even in challenging scenarios. Together, PTP-enabled switches, PRCs, and SSU-A clocks enable the precise timing required for the seamless functioning of advanced 5G networks.

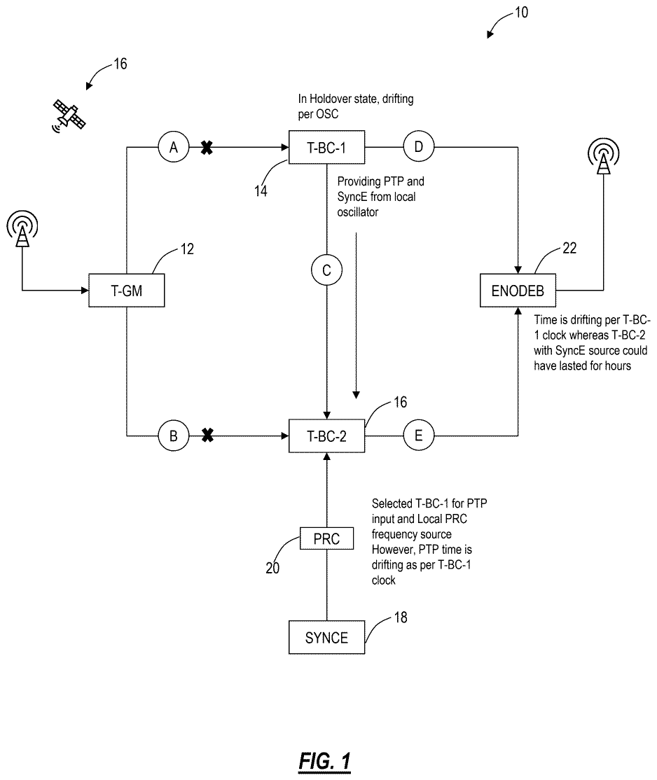

The duration a node can remain in holdover is directly determined by the quality of its frequency source. A node with a clock traceable to a PRC will typically exhibit slower time deviation compared to one relying on a SSU-A clock, which is less stable. In scenarios where two interconnected nodes lose connectivity to the Grandmaster Clock (GMC), the network protocol dictates that one node assumes the role of Master while the other becomes a Slave. The Slave node synchronizes with the Master and thus inherits the same rate of deviation as the Master. However, challenges arise when the node selected as the Master does not have a robust frequency backup and deviates rapidly. In such a case, even the Slave node, despite having a better frequency source, would deviate at the same accelerated rate as the Master, leading to suboptimal network synchronization. This issue is a direct consequence of the Best TimeTransmitter Clock Algorithm (BTCA) defined in ITU-T G.8275.2 Amd. 1 and G.8275.2. The BTCA selects the Master based on predefined criteria, which may not always account for the quality of the frequency backup, potentially compromising the stability and accuracy of the overall network timing during holdover. FIG. 1 illustrates a network diagram of a network 10 for illustration of the problems with the current BTCA approach.

A T-GM 12, or Telecom Grandmaster, is a specialized grandmaster clock used in telecommunications networks that implement PTP. Specifically defined in recommendations like ITU-T G.8275.1 and G.8275.2, the T-GM serves as the primary source of precise time and phase synchronization for telecom networks requiring high levels of accuracy. In the context of PTP, the T-GM 12 distributes accurate timing information to downstream network elements such as Telecom Boundary Clocks (T-BCs) 14, 16 and Telecom Time Slave Clocks (T-TSCs). The T-GM 12 interfaces with a highly accurate reference time source, typically a Global Navigation Satellite System (GNSS) 16 like GPS. The T-GM 12 then uses PTP to propagate this timing information across the network 10, ensuring that all devices are synchronized to the same precise time. The T-GM 12 is designed to meet the stringent synchronization requirements of modern telecom applications, such as 4G LTE-Advanced and 5G networks.

The BTCA in ITU-T G.8275.2 plays a vital role in ensuring robust time synchronization in networks with Partial Timing Support (PTS). G.8275.2 addresses scenarios where not all network elements provide full timing support, i.e., the PTS, making it more challenging to maintain synchronization accuracy. The BTCA is designed to select the Best Time Transmitter (BTT) among multiple PTP clocks available in the network 10. It evaluates various parameters, such as those contained in PTP Announce messages, including clock priority, clock quality, and stability, to determine the most reliable source of timing. In a PTS environment, where some nodes 14, 16 may lack full synchronization support, the BTCA ensures that nodes can make informed decisions about which time source to use. BTCA incorporates a focus on the quality of frequency backup and the reliability of timing inputs, which is critical for networks prone to disruptions or partial support scenarios. By selecting the most stable and accurate clock, the BTCA enhances the resilience of synchronization systems in G.8275.2 networks, ensuring continuity and precision in time distribution even when full timing support is unavailable. The Alternate Best Time Clock Algorithm (A-BTCA) is a variation of the BTCA designed to enhance timing resilience by incorporating additional criteria, such as topology awareness or specific network conditions, for selecting the Best Time Transmitter, whereas the standard BTCA primarily focuses on predefined parameters like clock quality and frequency backup, without accounting for network-specific factors.

With respect to the terms master and grandmaster, a grandmaster clock, e.g., the T-GM 12, is the primary source of time for the network 10. It is chosen based on its superior clock quality, stability, and attributes such as priority and accuracy. The grandmaster is responsible for providing the reference time to all other clocks in the network 10, which synchronize with it to maintain accurate timing. A master clock, on the other hand, is any clock in the network that is actively distributing timing information to other clocks (slaves) within its domain. While the grandmaster clock is always a master clock, not all master clocks are grandmaster clocks. For instance, in certain network configurations or holdover scenarios, a local node might become a master clock temporarily, distributing time to nearby devices even though it is not the primary reference (GMC). In BTCA, the distinction becomes significant during degraded scenarios or holdover periods. The algorithm may select a master clock to act as the active timing source based on its relative stability and quality in that specific context, even if it is not the original grandmaster. This ensures that timing accuracy is preserved as much as possible, especially in networks with Partial Timing Support (as in G.8275.1). Thus, while the grandmaster is the preferred ultimate time source, BTCA allows for flexibility in selecting an alternative master cock based on the best available timing conditions. The present disclosure addresses improvements in BTCA for selecting the master clock during disruptions to the grandmaster, for purposes of improving holdover.

In the network 10, the T-GM 12 and the T-BCs 14, 16 are at the nodes or network elements and links A, B, C, D, E interconnect the various nodes. For illustration purposes, the T-BC-2 16 has a backup local Synchronous Ethernet (SyncE) clock 18 other than its congruent primary PTP connection to the T-GM 12, thus if the T-BC-2 16 loses (due to degradation) the PTP connection, it still has its PRC 20 traceable to the SyncE clock 18. However, the existing BTCA does not check Frequency Traceability (one of the flags in the PTP Announce Message) of its local clock or the PTP clock input. As a result of this, BTCA may end up selecting, as its source, a PTP clock which is in holdover rather than selecting a better source, including one being in its Time holdover with an available PRC traceable Frequency input.

An example is illustrated in FIG. 1, where the T-BCs 14, 16 lose or have a degradation to the T-GM 12. Here, the BTCA on T-BC-2 16 selects T-BC-1 14 as its Time Transmitter for its PTP input, despite T-BC-2 16 having its PRC 20 traceable to the SyncE 18 frequency source. Consider following sequence of events:
(1) The T-GM 12 goes into Holdover.
(2) The T-BC-1 14 and the T-BC-2 16 also go into a Holdover state.
(3) The T-BC-1 14 and the T-BC-2 16 start publishing Holdover Clock Class (CC) to each other on the link C.
(4) The T-BC-1 14 and the T-BC-2 16 each run BTCA/A-BTCA algorithms and end up with one node as a Time Transmitter and the other as a Time receiver.
(5) In the given scenario, the T-BC-2 16 has the PRC 20 frequency input. Despite this fact, since BTCA/A-BTCA algorithms do not consider frequency traceable flags, the result may be that the T-BC-1 14 is selected as the Time Transmitter.

The selection of T-BC-1 14 as the time source is suboptimal because its time will drift according to the quality of its own oscillator. Similarly, an evolved Node B (eNodeB) 22 could end up using the T-BC-1 14 clock, causing its time to drift based on T-BC-1 14's holdover performance.

The present disclosure addresses the deficiencies in the above topology, namely that BTCA could still select the T-BC-1 14 as the time transmitter (which is drifting at faster rate than the T-BC-2 16). Of course, this adversely affects the holdover duration of the PTP clock considering the fact that the PRC 20 backup can provide a very long duration holdover to the network 10 as compared to a stratum 3 local oscillator at the T-BC-1 14.

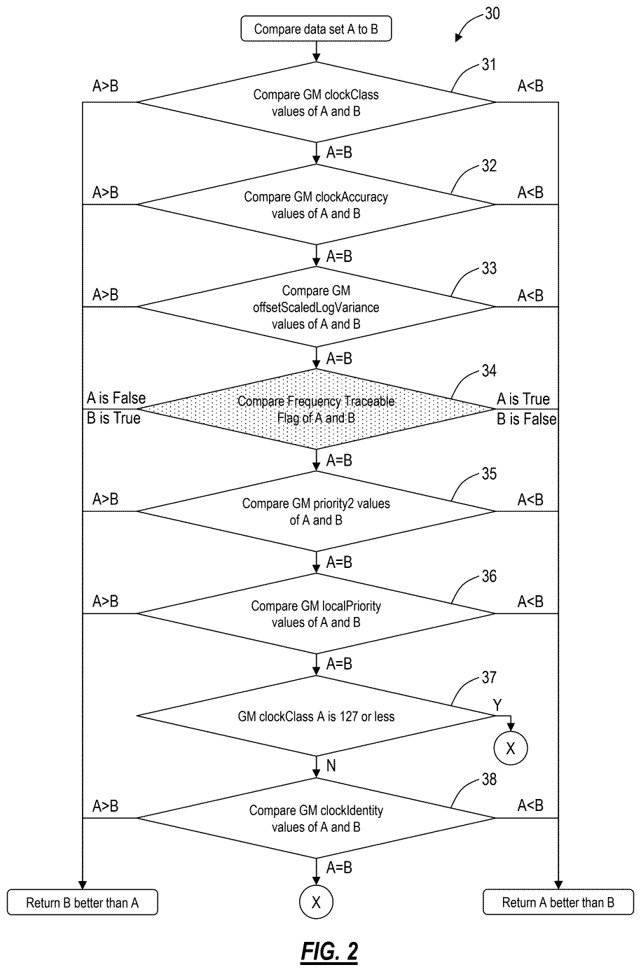

FIG. 2 illustrates a flowchart of a BTCA process 30 that includes consideration of frequency to overcome the deficiencies described with reference to FIG. 1. The BTCA process 30 is implemented by any node in the network 10, such as the T-BC-1 14, T-BC-2 16, and the eNodeB 22, when there is a need to select a new time transmitter. It is contemplated that the BTCA process 30 may be implemented as a method with steps, via circuitry configured to implement the steps, and as a non-transitory computer-readable medium storing instructions that, when executed, cause circuitry to implement the steps.

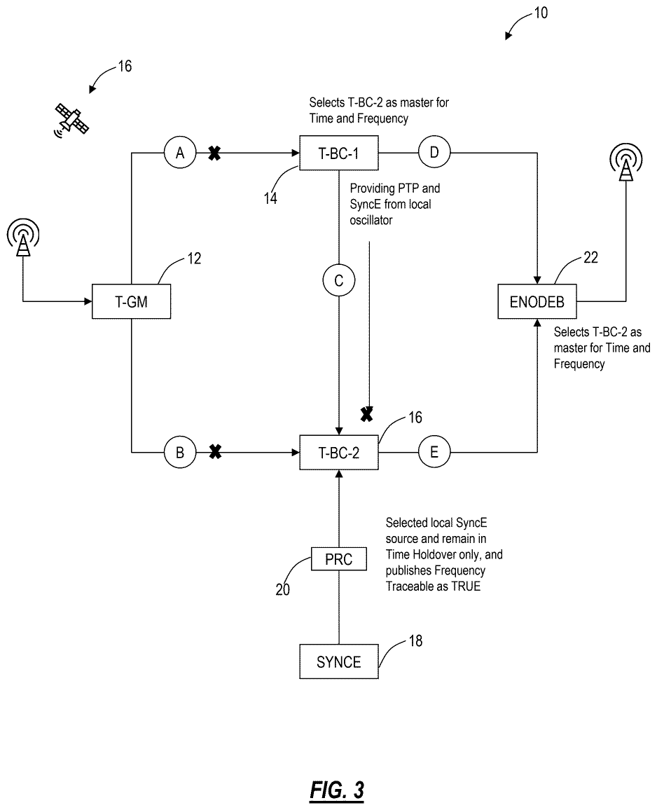

The BTCA process 30 is an enhancement of the BTCA specified in ITU-T Recommendation G.8275.2 Amendment 1, FIG. 3. The BTCA process 30 is used by a node to select a time transmitter based on the data sets, referred to as data sets A and B each of which correspond to the attributes of two distinct clocks being compared to determine the Best Time Transmitter (BTT). These data sets are constructed from parameters extracted from the PTP Announce messages exchanged between clocks in the network 10. The algorithm ensures systematic evaluation of both clocks to select the optimal timing source, essential for maintaining synchronization accuracy and stability. For example, in FIG. 1, the data set A could correspond to the T-BC-1 14 and the data set B could correspond to the T-BC-2 16.

The BTCA process 30 works be compared various points in the data sets A and B and selects either A or B at each step based on a comparison or moves to the next step if the values are equal. First, the BTCA process 30 compares the clockClass values of the data sets A and B (step 31), selecting the lower value or moving to the next step. That is, the lower clockClass value indicates the better clock. The clockClass values indicates a clock's traceability and stability, reflecting its synchronization quality and reliability within the network 10.

Next, the BTCA process 30 compares the clockAccuracy values of the data sets A and B (step 32), selecting the lower value or moving to the next step. Also, the lower clockAccuracy value indicates the better clock. The clockAccuracy values specify the precision of a clock's timekeeping relative to a reference standard, indicating how closely the clock's time aligns with the true time. Next, the BTCA process 30 compares the OffsetScaledLogVariance values of the data sets A and B (step 33), selecting the lower value or moving to the next step. The OffsetScaledLogVariance values quantify a clock's stability by measuring the variance of its time offset, providing insight into its precision and frequency consistency over time.

The present disclosure introduces a new check of a Frequency Traceable flag of the data sets A and B (step 34), selecting one that is true if the other is false, or moving to the next step if both are the same. The Frequency Traceable flag is an indicator within PTP message headers that specifies whether the clock's frequency is traceable to a recognized primary reference, such as the PRC 20. When this flag is set to ‘true,’ it signifies that the clock's frequency is derived from a reliable and accurate source, ensuring synchronization stability across the network. Conversely, if the flag is set to ‘false,’ it suggests that the clock's frequency may not be traceable to a primary reference, potentially affecting the precision of time synchronization. This flag is crucial for applications requiring high-precision timing, as it helps network devices assess the quality of the timing information they receive.

Generally speaking, traceability of a clock, or a clock's frequency, to a reference, may pertain to the property that the output of the clock can be related to the reference (which may also be a clock), through an unbroken chain of comparisons and/or dependencies. Each of the comparisons can have an associated uncertainty; each dependency can have an associated amount of error. Therefore, for example, a clock's frequency can be declared traceable to a primary reference clock on the basis that the clock's frequency depends on output of the primary reference clock either directly or indirectly. The dependency may be maintained via signals which are ongoing. A device may determine that a clock's frequency is traceable by determining the existence of such maintenance signals.

Next, the BTCA process 30 compares the priority2 values of the data sets A and B (step 35), selecting the lower value or moving to the next step. The priority2 values are a user-configurable parameter that provides a secondary level of priority for clock selection, allowing network administrators to influence the BTCA by assigning values between 0 and 255, where lower numbers indicate higher priority. Next, the BTCA process 30 compares the localPriority values of the data sets A and B (step 36). The localPriority values are a per-port configuration setting used as a tie-breaker when selecting between clocks received on different ports within a single network element, with lower values indicating higher priority.

Next, the BTCA process 30 checks if the ClockClass of clock A is less than 127 (step 37). This check is crucial because, in PTP, a ClockClass value of 127 indicates that a clock is in holdover mode, meaning it has lost synchronization with its primary reference source and is relying on its internal oscillator to maintain time. Clocks with a ClockClass less than 127 are considered to be synchronized to a valid time source and are therefore preferred over those in holdover mode. By performing this comparison, the BTCA ensures that clocks with active synchronization are prioritized as time sources, thereby enhancing the accuracy and stability of time distribution within the network.

Finally, the BTCA process 30 compares the clockIdentity values of the data sets A and B (step 38), selecting the lower value or not selecting either clock. The clockIdentity is a unique 64-bit identifier assigned to each clock, typically derived from the device's MAC address by inserting the hexadecimal value 0xFFFE in the middle, ensuring global uniqueness within the network.

By comparing the data sets A and B of two clocks, the BTCA process 30 supports the most stable and accurate clock being selected as the Best Time Transmitter (BTT). This selection can be critical in maintaining network synchronization, particularly during degraded scenarios such as holdover. The BTCA's structured evaluation process mitigates the risks of propagating timing errors by avoiding the selection of clocks with inferior attributes. Unlike the Best Master Clock Algorithm (BMCA), which uses similar parameters but focuses on selecting a Grandmaster Clock (GMC) during normal operation, the BTCA is specifically designed for choosing between potential time sources, especially in scenarios where holdover or timing degradation occurs. The BTCA's emphasis on a thorough, parameter-driven comparison provides enhanced stability in complex networks such as those operating under PTS.

An advantage of the BTCA process 30 is that it will work in the network 10 where third party devices are connected without causing any interoperability issues. That is, the BTCA process 30 works in the network 10 where some of the devices do not support the BTCA process 30. Here, those non-supportive devices use the BTCA process in ITU-T Recommendation G.8275.2 Amendment 1, FIG. 3, omitting the step 34. But all devices can include the BTCA process—either the BCTA process 30 or the BTCA process in ITU-T Recommendation G.8275.2 Amendment 1, FIG. 3, providing a selection of the Time Transmitter. The devices supporting the BTCA process 30 will advantageously make a better selection resulting in longer holdover support.

According to FIG. 2, a series of comparisons are made in order until a first one of the comparisons allows for a distinction of whether data set A or B is better. The comparison step 34 is included at a certain step in this order. The ordering of the steps can be as shown or else varied. Certain steps can be removed, or additional steps can be added. Other comparison approaches can also be used, for example in which two or more comparison steps are performed in parallel and the results combined.

FIG. 3 illustrates a network diagram of the network 10 for illustration of the BTCA process 30. The T-BC-2 16 would implement the BTCA process 30 and select the PRC 20 traceable SyncE source, remain in Time Holdover due to loss or degradation of the T-GM 12, and publish its Frequency Traceable flag as True in Holdover ClockClass (CC) to the T-BC-1 14 via the link C and the eNodeB 22 via the link E. In the BTCA process 30, the T-BC-1 sees the Frequency Traceable flag as true in the data set associated with the T-BC-2 16 thereby selecting the T-BC-2 16 in the BTCA process 30. The eNodeB 22 receives the same flag and similarly selects the T-BC-2 16. Now, all three of the T-BC-1 14, the T-BC-2 16, and the eNodeB 22 would stay in holdover much longer due to the stable PRC 20 as a reference.

The BTCA process 30 selects the BTT, serving as both the time source and/or the frequency source for synchronization. The BTCA evaluates potential clocks based on parameters such as clock quality (ClockClass), accuracy, and stability (OffsetScaledLogVariance) to ensure that the chosen source offers the most reliable and precise synchronization. As a time source, the selected clock provides the reference for distributing accurate timestamps across the network, ensuring devices stay synchronized in time. As a frequency source, it delivers a stable frequency reference that ensures consistent timing intervals, critical for applications requiring precise time alignment, such as 5G networks and financial trading systems. By addressing both time and frequency aspects, the BTCA process 30 supports that the network operates with desirably good or optimal synchronization stability and reliability, even under challenging conditions such as partial timing support or holdover scenarios.

Advantageously, a clock lasts longer in holdover mode with a stable frequency reference because the accuracy of its timekeeping during holdover depends entirely on the stability of its internal oscillator. A stable frequency reference, such as an Oven-Controlled Crystal Oscillator (OCXO) or a Rubidium oscillator, minimizes drift and frequency errors over time. These high-quality oscillators maintain a consistent frequency output, reducing the rate at which the clock's time deviates from the true time. Conversely, less stable references, like basic quartz oscillators, are more susceptible to temperature changes, aging, and other environmental factors, which cause faster and larger deviations in time. Consequently, a clock with a stable frequency reference can sustain precise timekeeping for longer durations in holdover, making it critical for applications where synchronization continuity is essential during disruptions.

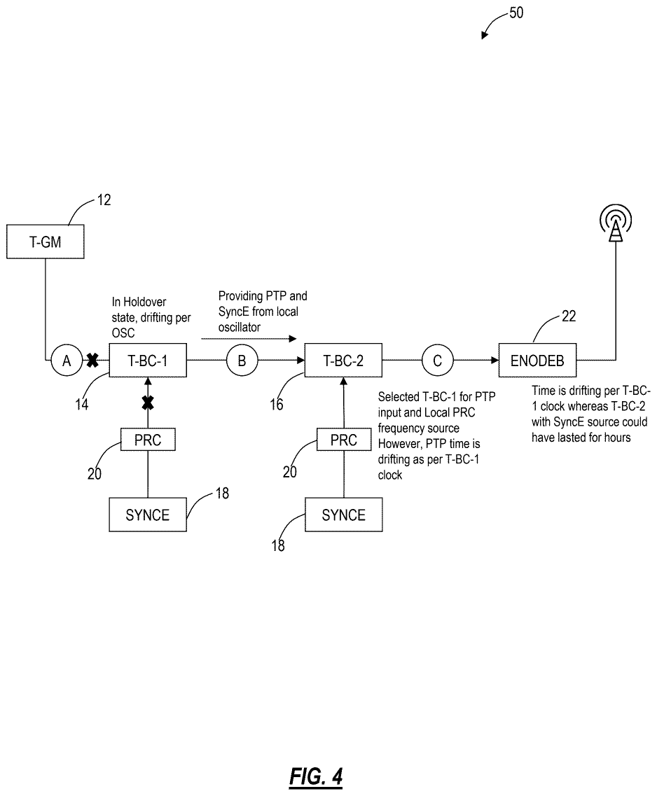

FIG. 4 illustrates a network diagram of a network 50 for illustrating another scenario where the BTCA decision may not be optimal based on the conventional approach. The network 50 includes the same nodes as the network 10 in a different interconnect via links A, B, C. With the conventional approach, ITU-T Recommendation G.8275.2 Amendment 1, FIG. 3:
(1) The connection between T-BC-1 14 and the T-GM 12 goes down on link A.
(2) The T-BC-1 14 goes into Holdover, starts publishing CC 135 (as per in-spec Holdover duration) with degraded Quality Level (QL), and Frequency Traceable as False. A Holdover Clock Class (Holdover CC) of 135 indicates that the clock is in holdover mode with a degraded time synchronization state. That is, the T-BC-1 14 has lost synchronization with its primary reference, such as the Grandmaster Clock (GMC), and is relying on its internal oscillator to maintain time. A clock with ClockClass 135 typically represents:

Degraded Holdover Accuracy: The clock is operating without an external reference and is likely to deviate over time due to limitations in the stability of its internal frequency source.

No Active Synchronization: It is no longer traceable to a primary time source, such as a GPS-synchronized PRC.

Operational Indication: This classification serves as an indicator to other network nodes that the clock is in holdover and should not be used as a preferred time source unless no better option is available.

Clocks with lower ClockClass values (e.g., 6 for PRC traceability) are always preferred over those with a Holdover CC of 135, as they represent more stable and accurate timing sources. This classification is vital in networks to ensure robust time synchronization even during degraded conditions.
(3) The T-BC-2 16 selects the T-BC-1 14 in the conventional BTCA process for time (PTP), but selects its local PRC 20 for frequency.
(4) The T-BC-1 14 PTP output is drifting without any frequency reference and it is publishing Frequency Traceable as False but since the conventional BTCA process does not check on Frequency Traceable flag value, the T-BC-2 16 BTCA selects the T-BC-1 14 for its Time input. The T-BC-1 14 in this case may also have a PRC 20 traceable to SyncE 18, but that connection is lost, degraded, etc.

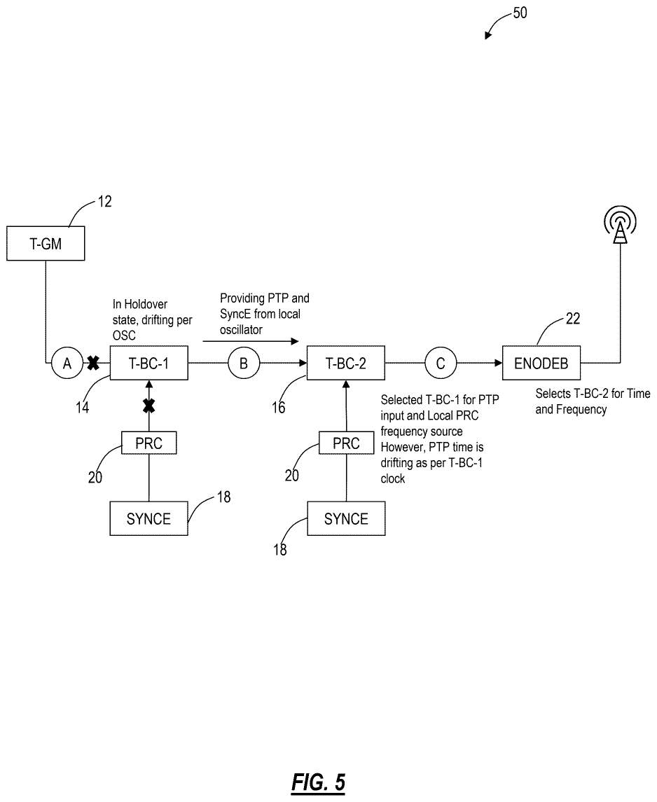

FIG. 5 illustrates a network diagram of the network 50 for illustration of the BTCA process 30. Here,
(1) The T-BC-2 16 BTCA process 30 checks that it has a local PRC frequency input.
(2) The T-BC-1 14 PTP Announce messages indicate that it is in Holdover with no Frequency input.
(3) The T-BC-2 16 decides not to select the T-BC-1 14 as input and remains in its Holdover with PRC frequency.
(4) The T-BC-2 16 publishes its Holdover CC with Frequency Traceable flag as TRUE.
(5) The eNodeB 22 remains locked with the T-BC-2 16 which is having PRC frequency input for long duration.

Additionally, with the PRC backup active, operator would have significantly more time to resolve the actual issue causing time holdover. This is advantageous to operations teams tasked with resolving the issue.

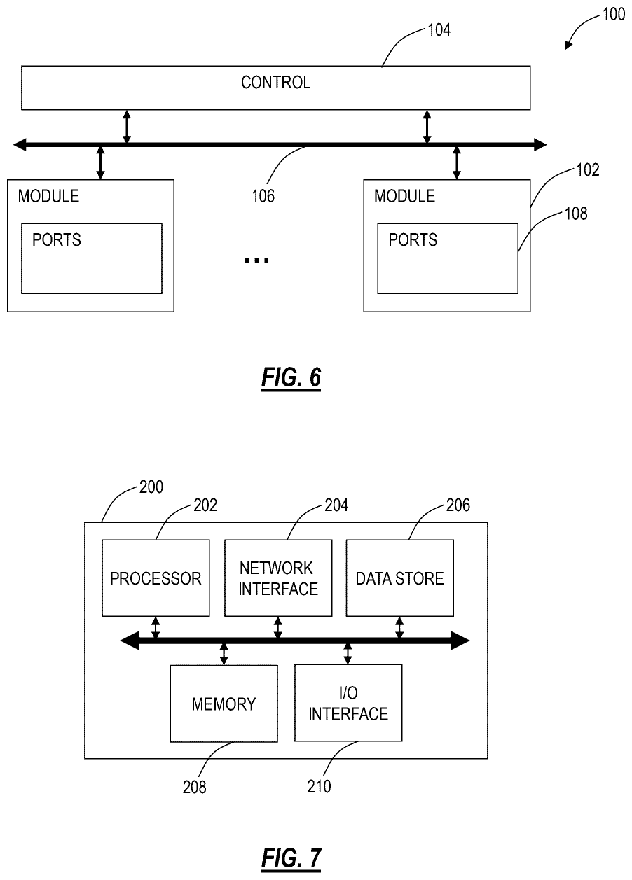

FIG. 6 illustrates a block diagram of a network element 100, depicted in a simplified functional format. It is important to note that a more practical design of this network element 100 would likely include additional components and processing logic to accommodate standard operating features, which are not detailed here. The network element 100 may represent any network element operable in a network using packet protocols, supporting PTP, and can include the T-GM 12, T-BC-1 14, T-BC-2 16, and the eNodeB 22. The network element 100 includes various interconnected modules, such as modules 102 and 104, via an interface 106. These modules, also known as blades or line cards, are typically mounted on the chassis of a data switching device. Each module can house numerous electronic or optical devices on a circuit board, complete with various interconnects, including interfaces to the chassis itself.

Specifically, the diagram illustrates two types of modules: line modules 102, which feature multiple Ethernet ports for external connections, and a control module 104. The line modules facilitate data traffic switching between ports via a switching fabric, integrated across the modules, potentially centralized in a separate unit or module, as well as a combination. This switching fabric includes hardware, software, and firmware that routes incoming data to the appropriate port. The control module 104 is equipped with a microprocessor, memory, software, and a network interface to manage operations such as configuration and monitoring of the network element 100. It may also communicate with external network management systems or databases that handle provisioning and operational data.

Lastly, while FIG. 6 provides a basic view, those skilled in the art will understand that the network element 100 could include additional components or be configured differently, such as in a distributed arrangement or as an integrated, rack-mounted unit (often referred to as a “pizza-box” configuration). This depiction in FIG. 6 is intended to convey functional aspects, with actual hardware implementations varying widely.

The hardware configuration of a T-GM 12 in the network element 100 is designed to serve as the primary source of precise time. It typically includes a highly accurate reference clock, such as a GPS/GNSS receiver or atomic clock, and an internal oscillator, such as a rubidium or oven-controlled crystal oscillator (OCXO), to maintain time during temporary losses of the external reference. The T-GM also includes time stamping units (TSUs) for generating and inserting accurate timestamps into PTP messages, ensuring sub-microsecond precision in time distribution. High-performance network interface cards (NICs) with multiple ports allow the T-GM to communicate with downstream devices, distributing time synchronization across the network, while synchronization control modules manage timing and monitor the system for issues, raising alarms when necessary. The T-BC, as an intermediary device, is configured to receive and forward timing messages from upstream clocks, such as the T-GM. It also includes time stamping units (TSUs) to adjust for delays and ensure accurate forwarding of timing data to downstream devices. T-BCs have high-performance network interfaces and built-in oscillators (typically TCXOs or OCXOs) to maintain time accuracy during brief disruptions. The hardware also includes packet-processing engines for low-latency handling of PTP messages and monitoring systems for detecting synchronization issues. Both T-GM and T-BC devices support redundancy and monitoring features like SNMP to ensure reliable time synchronization in telecom networks, where accuracy is critical.

FIG. 7 illustrates a block diagram of an example processing device 200. The processing device 200 may be integrated within the network element 100 or function as a standalone unit connected to the network element 100. It may also be known as an apparatus, a control module, shelf controller, shelf processor, or system controller. The core of the processing device 200 is a processing unit 202, a hardware unit that runs software instructions. The processing unit 202 could be one or more custom or commercially available processors, i.e., one or more processors. During operation, the processing unit 202 executes software from memory, manages data communication with the memory, and controls the processing device 200 operations based on the software.

The processing device 200 also features several components connected to the processing unit 202: a network interface 204, a data store 206, memory 208, and an I/O interface 210. The network interface 204, possibly an Ethernet device, allows the processing device 200 to communicate over a data network and includes necessary connections for address, control, and data communication. The data store 206 stores various types of data such as telemetry data, Operations, Administration, Maintenance, and Provisioning (OAM&P) data, etc., and may include both volatile (e.g., RAM) and nonvolatile (e.g., ROM, hard drives) memory elements. Similarly, the memory 208 includes volatile and nonvolatile storage media, potentially employing a distributed architecture where components are located remotely but accessible by the processing unit 202. The I/O interface facilitates communication between processing device 200 and external devices.

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

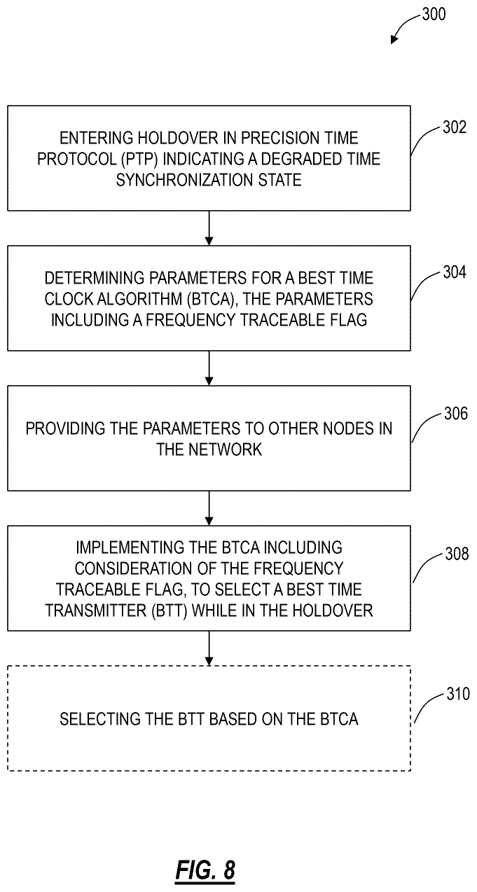

FIG. 8 illustrates a flowchart of a process 300 for an enhanced BTCA process that enhances time holdover in a PTP network involve leveraging the best available frequency support while disqualifying time input from a degraded PTP clock. The process 300 contemplates implementation as a method with steps, via circuitry such as at the network element 100 configured to implement the steps, and as a non-transitory computer-readable medium storing instructions that, when executed, cause circuitry to implement the steps.

The steps include entering holdover in Precision Time Protocol (PTP) indicating a degraded time synchronization state (step 302); determining parameters for a Best Time Clock Algorithm (BTCA), the parameters including a Frequency Traceable flag (step 304); providing the parameters to other nodes in the network (step 306); and implementing the BTCA including consideration of the Frequency Traceable flag, to select a Best Time Transmitter (BTT) while in the holdover (step 308). The steps can include selecting the BTT based on the BTCA (step 310).

The BTT can be a local Primary Reference Clock (PRC) having frequency traceability. The frequency traceability is to a Synchronous Ethernet (SyncE) source. The Frequency Traceable flag can be set to TRUE, and the consideration of the Frequency Traceable flag in the BTCA includes selecting a clock where the Frequency Traceable flag is TRUE over another clock where it is FALSE.

The consideration of the Frequency Traceable flag in the BTCA includes selecting a clock where the Frequency Traceable flag is TRUE over another clock where it is FALSE. The various parameters include one or more of clockClass, clockAccuracy, OffsetScaledLogVariance, priority2, localPriority, and clockIdentity. The BTCA selects a clock having a lower value of the various parameters or the Frequency Traceable flag as TRUE.

The BCTA selects a clock having values of the parameters which are preferred, according to a predetermined selection scheme, the selection scheme including that the Frequency Traceable flag being TRUE is preferred over the Frequency Traceable flag being FALSE. The Frequency Traceable flag is set based on whether a clock's frequency is traceable to a primary reference. The Frequency Traceable flag can be set to FALSE, and wherein the implementing the BTCA including consideration of the Frequency Traceable flag includes selecting another clock for the BTT with the another clock having its Frequency Traceable flag set to TRUE.

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner—whether collectively, in subsets, or individually—thereby broadening the range of potential embodiments.

What is claimed is:

1. A network element in a network comprising circuitry configured to:
enter holdover in Precision Time Protocol (PTP) indicating a degraded time synchronization state,
determine parameters for a Best Time Clock Algorithm (BTCA), the parameters including a Frequency Traceable flag,
provide the parameters to other nodes in the network, and
implement the BTCA including consideration of the Frequency Traceable flag, to select a Best Time Transmitter (BTT) while in the holdover.

2. The network element of claim 1, wherein the BTT is a local Primary Reference Clock (PRC) having frequency traceability.

3. The network element of claim 2, wherein the frequency traceability is to a Synchronous Ethernet (SyncE) source.

4. The network element of claim 3, wherein the Frequency Traceable flag is set to TRUE, and the consideration of the Frequency Traceable flag in the BTCA includes selecting a clock where the Frequency Traceable flag is TRUE over another clock where it is FALSE.

5. The network element of claim 1, wherein the consideration of the Frequency Traceable flag in the BTCA includes selecting a clock where the Frequency Traceable flag is TRUE over another clock where it is FALSE.

6. The network element of claim 1, wherein the various parameters include one or more of clockClass, clockAccuracy, OffsetScaledLogVariance, priority2, localPriority, and clockIdentity.

7. The network element of claim 6, wherein the BTCA selects a clock having a lower value of the various parameters or the Frequency Traceable flag as TRUE.

8. The network element of claim 1, wherein the BCTA selects a clock having values of the parameters which are preferred, according to a predetermined selection scheme, the selection scheme including that the Frequency Traceable flag being TRUE is preferred over the Frequency Traceable flag being FALSE.

9. The network element of claim 1, wherein the Frequency Traceable flag is set based on whether a clock's frequency is traceable to a primary reference.

10. The network element of claim 1, wherein the Frequency Traceable flag is set to FALSE, and wherein the implementing the BTCA including consideration of the Frequency Traceable flag includes selecting another clock for the BTT with the another clock having its Frequency Traceable flag set to TRUE.

11. A method comprising steps of:
entering holdover in Precision Time Protocol (PTP) indicating a degraded time synchronization state;
determining parameters for a Best Time Clock Algorithm (BTCA), the parameters including a Frequency Traceable flag;
providing the parameters to other nodes in the network; and
implementing the BTCA including consideration of the Frequency Traceable flag, to select a Best Time Transmitter (BTT) while in the holdover.

12. The method of claim 11, wherein the BTT is a local Primary Reference Clock (PRC) having frequency traceability.

13. The method of claim 12, wherein the frequency traceability is to a Synchronous Ethernet (SyncE) source.

14. The method of claim 13, wherein the Frequency Traceable flag is set to TRUE, and the consideration of the Frequency Traceable flag in the BTCA includes selecting a clock where the Frequency Traceable flag is TRUE over another clock where it is FALSE.

15. The method of claim 11, wherein the consideration of the Frequency Traceable flag in the BTCA includes selecting a clock where the Frequency Traceable flag is TRUE over another clock where it is FALSE.

16. The method of claim 11, wherein the various parameters include one or more of clockClass, clockAccuracy, OffsetScaledLogVariance, priority2, localPriority, and clockIdentity.

17. The method of claim 16, wherein the BTCA selects a clock having a lower value of the various parameters or the Frequency Traceable flag as TRUE.

18. The method of claim 11, wherein the BCTA selects a clock having values of the parameters which are preferred, according to a predetermined selection scheme, the selection scheme including that the Frequency Traceable flag being TRUE is preferred over the Frequency Traceable flag being FALSE.

19. The method of claim 11, wherein the Frequency Traceable flag is set based on whether a clock's frequency is traceable to a primary reference.

20. The method of claim 11, wherein the Frequency Traceable flag is set to FALSE, and wherein the implementing the BTCA including consideration of the Frequency Traceable flag includes selecting another clock for the BTT with the another clock having its Frequency Traceable flag set to TRUE.
